(19) United States
(12) Patent Application Publication
(10) Pub. No.: US 2008/0073813 A1
(43) Pub. Date: Mar. 27, 2008

(54) Vehicle Trim Panel with Multiple Decorative Characteristics

(75) Inventors: Nels R. Smith, Zeeland, MI (US); Andrew R. Butz, Zeeland, MI (US); Brian R. Dexter, Grand Haven, MI (US)

Correspondence Address: FOLEY & LARDNER LLP, 777 EAST WISCONSIN AVENUE, MILWAUKEE, WI, 53202-5306, US

(73) Assignee: JOHNSON CONTROLS TECHNOLOGY COMPANY

(21) Appl. No.: 11/792,317

(22) PCT Filed: Dec. 16, 2005
(86) PCT No.: PCT/US05/45898

§ 371 Date: Jun. 5, 2007

Related U.S. Application Data
(60) Provisional application No. 60/637,036, filed on Dec. 17, 2004.

(51) Int. Cl. B29C 45/14; B60J 5/00

(52) U.S. Cl. 264/266; 296/146.7

(57) ABSTRACT

A panel for use in a vehicle interior is disclosed. The panel includes a unitary integral one-piece flexible member (e.g., coverstock) having a first portion with a first ornamental appearance and a second portion with a second ornamental appearance, and a substrate at least partially molded behind the flexible member. A border between the first portion and the second portion is located in a recess formed when the substrate is molded. A method of forming a panel also is disclosed. The method includes moving a first mold section toward a second mold section so that a projection of the mold pushes a portion of the flexible member at least partially into a recess of the mold, and injecting a polymer resin between the flexible member and the first mold section so that the border is located in the recess.

### CROSS-REFERENCE TO RELATED PATENT APPLICATIONS

The present PCT Application claims priority to U.S. Provisional Patent Application No. 60/637,036 titled VEHICLE TRIM PANEL WITH CONVERSTOCK HAVING MULTIPLE DECORATIVE ELEMENTS and filed on Dec. 17, 2004, the full disclosure of which is hereby incorporated herein by reference.

### BACKGROUND

The present application relates generally to the field of molded articles or components having a substrate and a coverstock that has two or more portions with different or contrasting ornamental appearance. More particularly, the present invention relates to vehicle trim panels that include a molded substrate and a unitary or one-piece coverstock having two or more portions that have different decorative elements.

It is generally known to provide a laminated panel that includes a differentially segmented cover layer bonded to a rigid substrate that has been softened by heat. Such known cover layers comprise multiple sheets connected along seams. Such known trim panels are made by placing the lower layer and the substrate sheet or panel in a mold and closing the mold so that a projection presses a portion of the cover layer and the substrate into a recess. However, such known methods require multiple sheets connected to provide the cover layer and a panel for the substrate that includes additional separate steps to soften and place the panel in the mold.

It is also generally known to partially or completely vacuum form a surface skin member and place the preformed member in a mold with additional ornamental sheets, before resin is injected into the mold and the mold then closed to distribute the resin and to shape the surface skin member into the final product. However, such known processes require multiple preliminary operations and creation of different preformed components.

FIGS. 13 and 14 show examples of known processes. FIG. 13 is a flow diagram of a known process of making a vehicle door panel with a coverstock with two bolsters. This known process comprises forming an upper bolster and a lower bolster. Each bolster is formed by cutting a vinyl sheet, molding an upper bolster substrate and a lower bolster substrate (e.g., in separate mold tools), gluing the vinyl sheet to the respective upper/lower bolster substrates, vacuum wrapping the sheets and their edges to the bolster substrates, and trimming excess vinyl sheet from the resulting laminate. The process also includes separately molding a main or primary substrate and then assembling the bolsters to the primary substrate to provide the completed assembly. The assembly may include heat staking the upper and lower bolsters to the primary substrate.

FIG. 14 is a flow diagram of a known process of making a vehicle door panel with two bolsters. The process includes forming an upper bolster and a lower bolster. Each bolster is formed by cutting a sheet (e.g., of vinyl), vacuum form the sheet to a desired shape, trimming the preformed sheet. The two bolsters are joined together (e.g., welded) and this combined skin is inserted into a tool and the primary substrate is molded to form the completed assembly.

Accordingly, it would be advantageous to provide a molded article having a one-piece coverstock with sections having different ornamental appearances/decorative elements. It would also be advantageous to provide a vehicle trim panel where the coverstock is designed so that the border between the different decorative elements becomes embedded in a recess formed in a substrate that provides structural support to the trim panel. It would further be advantageous to decorative elements embedded into the substrate when the substrate is molded.

### SUMMARY

The invention is directed to a panel for use in a vehicle interior. The panel comprises a flexible member (e.g., coverstock) having a first portion with a first ornamental appearance and a second portion with a second ornamental appearance; and a substrate at least partially molded behind the flexible member. The interface between the first portion and the second portion is located in a recess formed in the substrate. The flexible member may be a sheet of material selected from the group of textile, fabric, natural, polymer, and combinations thereof. The flexible member may include a first layer and a second layer coupled to the first layer is selected from the group of textile, fabric, natural, polymer, and combinations thereof. The substrate may be molded entirely or partially behind or against a portion of the flexible member.

The invention is also directed to a method of forming a panel comprising providing a flexible member between a first mold section and a second mold section. The flexible member has a demarcation separating a first portion with a first ornamental appearance and a second portion with a second ornamental appearance. One of the first mold section and second mold section having a recess and the other of the first mold section, and second mold section having a projection aligned with the recess. The method further includes moving the first mold section toward the second mold section so that the projection pushes a portion of the flexible member at least partially into the recess, and injecting a polymer resin between the flexible member and the first mold section to form a substrate so that the demarcation is located in a recess formed in the substrate.

### BRIEF DESCRIPTION OF THE DRAWINGS

FIG. 1 is a fragmentary perspective view of vehicle interior having a door and an instrument panel, according to a preferred embodiment.

FIG. 2 is a sectional view of the door trim panel.

FIG. 3 is a perspective view of a roll of coverstock material.

FIG. 4 is a top plan view of a coverstock segment cut from the roll shown in FIG. 3.

FIG. 5 is sectional view of an open mold with the coverstock located between mold sections.

FIG. 6 is a sectional view of the mold sections closed around the coverstock.

FIG. 7 is a sectional view of resin material injected into the mold to form the substrate and joint to the coverstock.

FIG. 8 is a fragmentary perspective sectional view of the coverstock captured within a recess formed in the substrate.

FIG. 9 is a perspective view of a process for texturing, printing, and die cutting the coverstock.

FIG. 10 is a schematic view of the process for forming the door trim panel.

FIG. 11 is a flow diagram of a process of making a vehicle door panel with a coverstock with two or more printed decorative characteristics or elements according to an exemplary embodiment.

FIG. 12 is a flow diagram of a process of making a vehicle door panel with a coverstock with two or more painted decorative characteristics or elements according to an exemplary embodiment.

FIG. 13 is a flow diagram of a known process of making a vehicle door panel with a coverstock with two bolsters.

FIG. 14 is a flow diagram of a known process of making a vehicle door panel with two bolsters.

### DETAILED DESCRIPTION OF THE PREFERRED EMBODIMENTS

Before explaining a number preferred, exemplary, and alternative embodiments in detail it is to be understood that the invention is not limited to the details of construction and the arrangement of the components set forth in the following description or illustrated in the drawings. The invention is capable of other embodiments or being practiced or carried out in various ways. It is also to be understood that the phraseology and terminology employed herein is for the purpose of description and should not be regarded as limiting. For example, the terms “substrate,” “coverstock,” and “decorative elements” are intended to be broad terms and not terms of limitation. These components may be used with any of a variety of products or arrangements and are not intended to be limited to use with automotive applications.

In general, the component or molded article described in this disclosure is a molded article having a substrate coupled to a coverstock with two or more portions having different ornamental appearances. In one embodiment, the molded article is configured as a trim panel for use in a vehicle (e.g., automobiles such as cars, vans, sport utility vehicles, trucks, buses, airplanes, boats, etc.). Providing a trim panel with a unitary or one-piece coverstock having sections with different ornamental appearances is intended to allow for a wide variety of decorative element possibilities for trim panels on a wide variety of vehicles (e.g., economy, luxury, etc.) in view of manufacturing efficiencies associated with the production of the coverstock and molding the substrate against the coverstock.

The molded article described in this disclosure may be employed in a variety of applications, and is generally applicable with any application where it would be beneficial to provide a molded article having two or more areas or portions of different decorative elements that are registered to specific areas of the panel. When the molded article is a trim panel for use in a vehicle, it is suitable for use in an interior passenger compartment of a vehicle, and may find utility in the form of door panels, dashboards, instrument panels, consoles, sidewall trim, overhead liners, or other vehicle components or portions thereof. While the disclosed embodiments may be described as a vehicle trim panel, such as a door panel, the features of the disclosed embodiments are equally applicable with other applications such as other panels, molded articles and components and other office, home, or educational, industrial, commercial, or consumer products which employ localized areas or regions of various or different ornamental appearances.

Also, the particular materials used to construct the exemplary embodiments are also illustrative. For example, injection molded polypropylene is the preferred method and material for making the substrate, but other materials can be used, including other thermoplastic resins such as polyethylene, acrylonitrile butadiene styrene (“ABS”), polyurethane nylon, any of a variety of homopolymer plastics, copolymer plastics, plastics with special additives, filled plastics, etc. Also, other molding operations may be used to form these components, such as injection compression molding, etc. The coverstock is preferably made from textile (woven, non-woven, knit, etc.), but can be made from any of a variety of materials and compositions including fabric, cloth, natural material (e.g., leather, etc.), polymer (e.g., thermoplastic elastomer polyolefin (TPO), vinyl, or materials formed by reaction injection molding (RIM), etc.), elastomer, or the like or combinations thereof; and may have multiple layers (e.g., outer, inner, scrim, etc.).

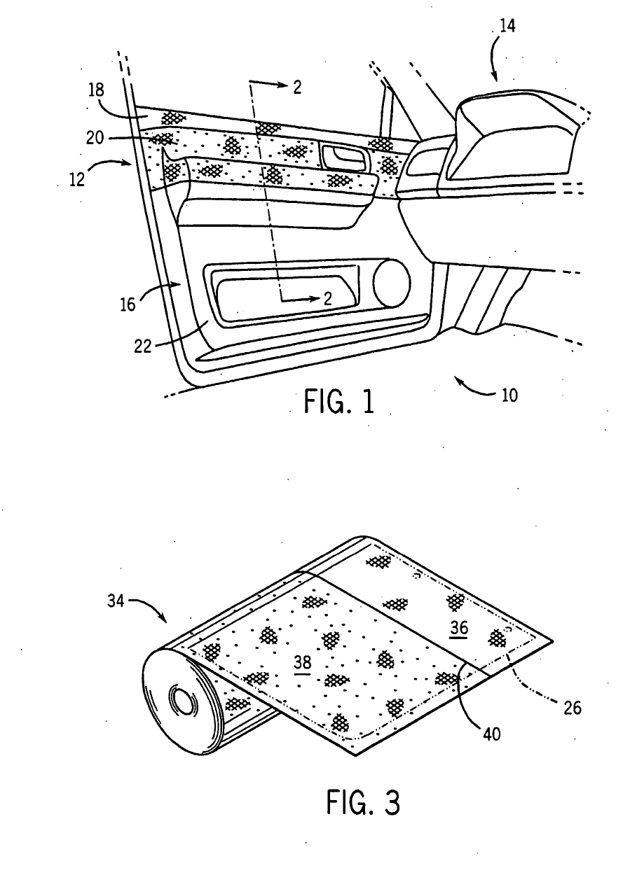

Proceeding now to descriptions of the preferred and exemplary embodiments, FIG. 1 shows a perspective view of a vehicle interior 10 (e.g., passenger compartment). Interior 10 is shown to include a door 12 and an instrument panel 14. Door 12 and instrument panel 14 each may comprise an outer trim component or panel that is formed by a sheet of material (e.g., flexible member, skin, sheet, foil, coverstock, etc.) joined to a base (e.g., rigid member, substrate, etc. that is molded behind the entire coverstock, partially molded behind the coverstock, etc.). For the purposes of this disclosure, a trim panel 16 coupled to door 12 will be further described, but it would be understood by a person having ordinary skill in the art reading this disclosure that the trim panel could be coupled to instrument panel 14, or other surfaces within the vehicle, or used in other applications where a panel with multiple decorative elements is desired.

Trim panel 16 coupled to door 12 includes an upper portion 18 (shown as a window edge), a middle portion 20 (shown as a bolster and an armrest), and a lower portion 22 (shown to include a storage pocket). The ornamental appearance of door trim panel 16 comprises a polymeric lower portion 22 and an upper portion 18 and middle portion 20 that have the appearance of being made from two separate coverstocks.

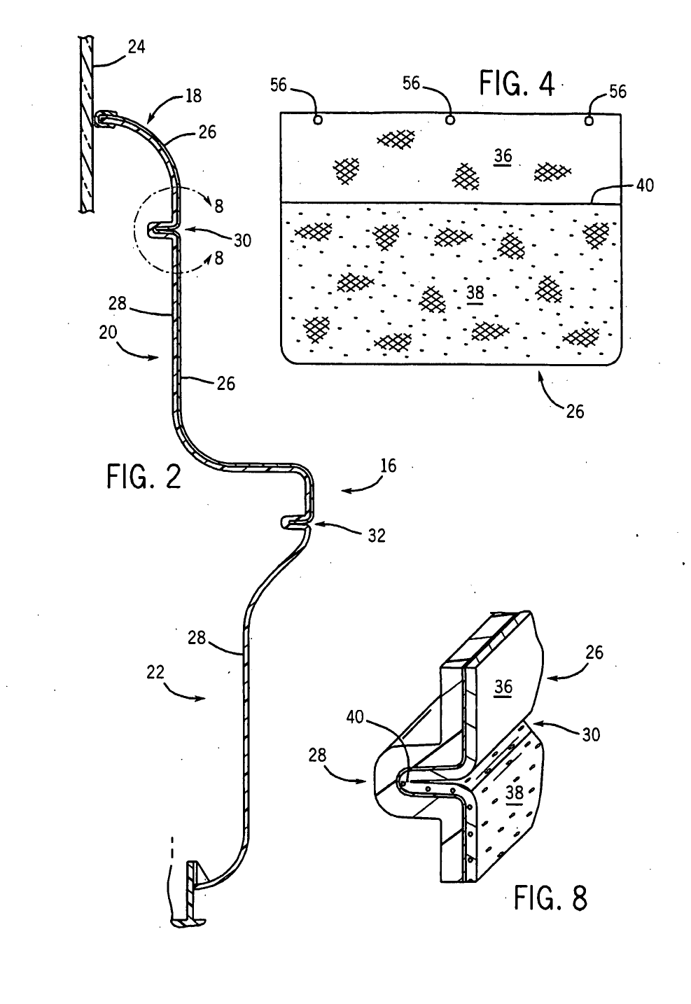

Referring to FIG. 2, trim panel 16 is shown adjacent a window 24 and comprises a sheet (shown as a coverstock 26) joined to a base (shown as a substrate 28). Upper portion 18 of trim panel 16 is separated from middle portion 20 of trim panel 16 by a first recess 30 formed in coverstock and substrate. Middle portion 20 of trim panel 16 is separated from lower portion 22 of trim panel 16 by a second recess 32 formed in substrate 28.

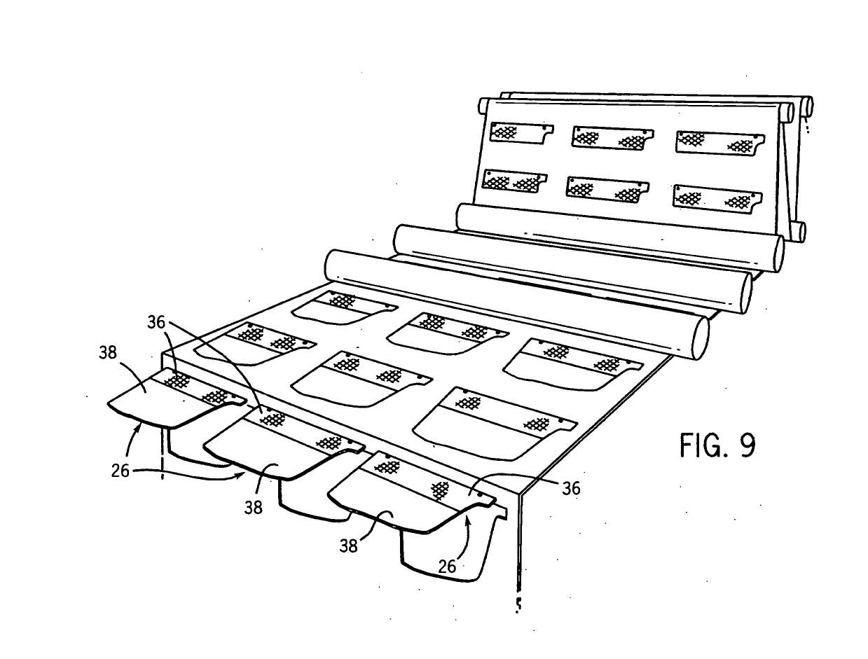

Referring to FIG. 3, a roll 34 of coverstock material is shown prior to fabrication of coverstock 26 that is used to form trim panel 16 (e.g., prior to being stamped, cut, etc.). FIG. 9 is a perspective view of a process for texturing, printing, and die cutting the coverstock. Referring to FIGS. 3 and 4, coverstock 26 comprises a first portion 36 and a second portion 38. First portion 36 of coverstock 26 comprises a first decorative characteristic or element and second portion includes a second decorative characteristic or element different than the first decorative element. The decorative elements may provide any of a variety of ornamental appearances such as colors, textures, patterns (e.g., images, indicia, text, designs, etc.), or combinations thereof that are formed, added, provided on, printed on, painted on, or otherwise disposed on the side or surface of the coverstock 26 that ultimately at least partially faces the vehicle interior 10 (e.g., the visible surface or the “A-surface”). Coverstock 26 may be made from any of a variety of materials and compositions including fabric (woven, non-woven, etc.) textile, natural, polymer, or the like or combinations thereof; and may have multiple layers (e.g., outer, inner, scrim, etc.).

According to exemplary embodiments, coverstock 26 provides two or more delineations that are registered (e.g., designed, located, disposed, assigned, etc.) to specific areas (e.g., portions, regions, sections, etc.) of trim panel 16. Registered textures or patterns can be added to the base, one-piece sheet by embossing and other methods known to those skilled in the art of fabric or sheet manufacture. Registered colors or patterns can be applied to the base, one-piece sheet with various silkscreen or ink application processes. For example, the coverstock material may be fabricated by feeding the roll 34 of fabric through one or more machines that apply one or more registered textures or patterns and/or one or more registered colors or patterns to provide varied ornamental appearances on a single piece of fabric. According to a preferred embodiment, decorative elements are printed e.g., with ink, paint, dye, laser printing, ink jet, painting, etc.) on the A-surface of coverstock that has been embossed with a texture, using any of a variety of conventionally known methods (e.g., pressure embossing, thermal embossing, etc.). According to alternative embodiments, the decorative elements are provided on the coverstock by adding material (e.g., deposits of polymeric adhesives, paint or other materials) on the A-surface of coverstock. The different decorative appearance may be provided by two different elements applied to the coverstock, or a single element applied to the coverstock that provides a different decorative appearance (or texture) than the rest of the coverstock. According to another alternative embodiment, decorative elements are provided on coverstock by physical or chemical alterations to the A-surface of coverstock (e.g., attaching elements, embossing, stamping, heat application, ultrasonic, etc.). FIG. 9 is a perspective view of a process for texturing, printing, and die cutting the coverstock according to an exemplary embodiment.

Separating first portion 36 from second portion 38 is a border 40 (e.g., interface, demarcation, delineation, division, line, etc.). FIGS. 3 and 4 show border 40 as a linear line, but the border may be provided as an accurate line, enclosed sections or regions (e.g., circular, elliptical, oval, square, rectangular, etc.) on the A-surface of the one-piece coverstock 26, or the like. Such a single piece of fabric with multiple ornamental or decorative demarcations is then be placed into a mold (tool) and molded so that the different areas of the fabric correspond to different areas of the panel (e.g., a door panel upper and lower bolsters). According to alternative embodiments, the coverstock may be provided with three or more portions having two or more different decorative elements.

Referring to finished trim panel 16 in FIGS. 2 and 8, border 40 between first portion 36 and second portion 38 of coverstock 26 is located in first recess 30 formed in substrate 28 when substrate 28 is molded against or behind coverstock 26.

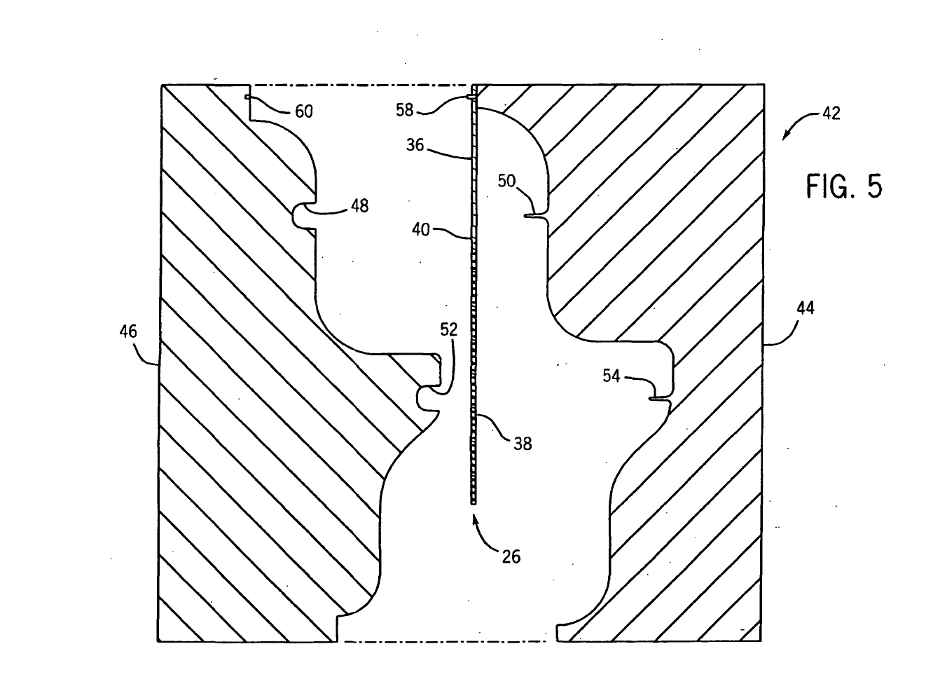

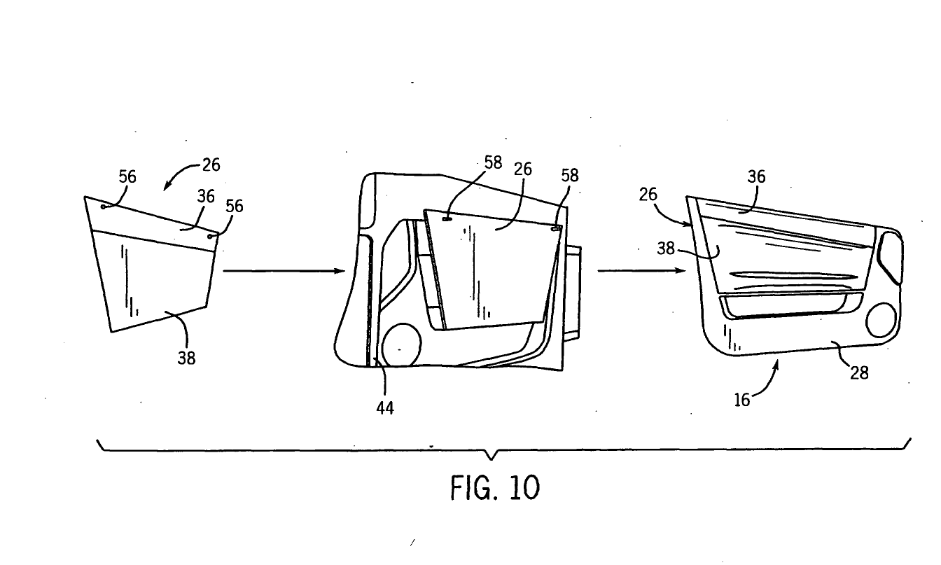

FIG. 10 is a schematic view of a process for forming the door trim panel according to an exemplary embodiment. Referring to FIGS. 5-7, first recess 30 and second recess 32 in substrate is provided or formed during the molding operation that forms substrate 28. FIG. 5 shows a mold 42 having a first mold section (shown as a cavity 44) and a second mold section (shown as a core 46). The interior surface of cavity 44 includes a first recess 48 to at least partially receive a first projection 50 extending from core 46, and a second recess 52 configured to receive at least a portion of a second projection 54 extending from core 46. First projection 50 and second projection 54 may be any of a variety of members extending from the surface of the core (e.g., blade, pins, etc.). Placement and location of recesses and projections on the illustrated mold sections are exemplary, such that one or both (or more as the design may provide) may be on the other mold section.

Coverstock 26 is positioned between cavity 44 and core 46 when mold 42 is open. According to an exemplary embodiment, coverstock 26 includes apertures 56 (shown in FIG. 4) that receive projections (shown as pins 58) extending from core 46. In this position, coverstock 26 is suspended (e.g., hangs) from pins 58. Pins 58 are configured to engage recesses 60 in cavity 44 when the mold 42 closes. Coverstock 26 may be placed in mold 42 by any of a variety of techniques including robotic placement, manual placement, vacuum device, adhesive, or the like.

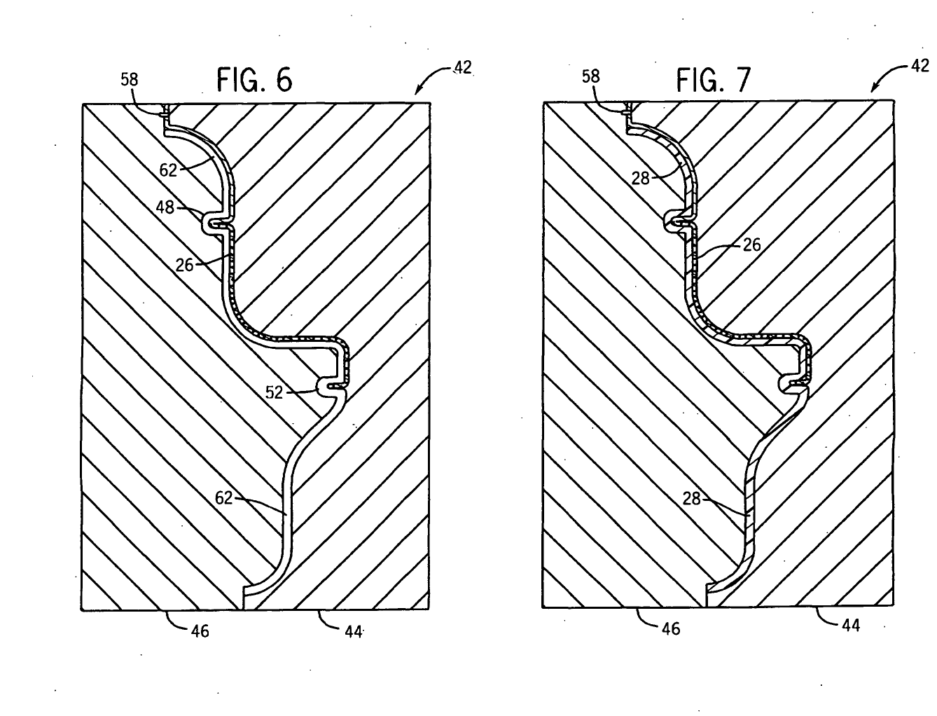

FIG. 6 shows mold 42 closed around coverstock 26 (e.g., by moving the mold sections toward each other (or one of the sections towards the other section) so that a cavity or gap 62 is provided between core 46 and cavity 44. The placement and orientation of coverstock 26 generally follows the contours of the mold sections.

Referring to FIG. 7, molten polymer resin is injected into gap 62 between core 46 and coverstock for upper portion 18 and middle portion 20 of trim panel 16 between cavity 44 and core 46 for lower portion 22 of trim panel 16. As molten plastic resin fills gap 62, coverstock 26 is pressed against the surface of core 46 and takes the shape of the surface of core 46 (i.e., the desired final shape of trim panel). According to an exemplary embodiment, the substrate is molded such that the coverstock is disposed over a portion of the substrate (e.g., partial mold behind) and the non-covered portion of the substrate may provide a portion of the A-surface of the trim panel. According to another exemplary embodiment, the substrate is molded such that the coverstock is disposed over the entire substrate (e.g., mold behind) and the coverstock provides the entire A-surface of the combined article.

Referring to FIGS. 2, 7, 8, first recess 48 in cavity 44 and first projection 50 on core 46 are configured (e.g., located, oriented, etc.) so that border 40 is located or disposed within first recess 48 after polymer resin has been injected into gap 62. Also, second recess 52 in cavity 44 and second projection 54 on core 46 are likewise positioned or located so that the edge of coverstock 26 is disposed in second recess 52 after polymeric molten resin has filled gap 62. When mold 42 is opened, projections 50, 54 are removed from recesses 30, 32 formed in coverstock 26 and/or substrate 28, and from recesses 48, 52.

According to an exemplary embodiment, the demarcations between upper portion 18, middle portion 20, and/or lower portion 22, are defined by the general desired configuration or ornamental appearance of door trim panel 16. Likewise, placement of recesses 30, 32 (and border 40, projections 50, 54, and recesses 48, 52) are designed or configured according to the desired design and ornamental appearance of trim panel 16. As such, first recess 48 and second recess 52 are similarly defined in position by this design; and coverstock 26 is designed (configured) so that border 40 between first portion 36 and second portion 38 ends up being located in first recess 48 in substrate 28. According to a preferred embodiment, the relative location of border 40 (between first portion 36 and second portion 38 in coverstock 26) is determined by analyzing and testing the properties (e.g., stretch, elongation, movement within the mold during molding of the substrate, etc.) of the material or materials used to form coverstock 26 (e.g., empirically, trial and error, computer software or program, or the like) and the flow and pressure of the injected plastic during molding of the substrate. These characteristics and properties are then applied and used to design coverstock 26.

After plastic resin forms substrate 28, the trim panel 16 can undergo any of a variety of finishing operations (e.g., removing any portions of coverstock not attached to substrate (e.g., the portion or strip containing apertures), wrapping around and coupling to the B surface of substrate (e.g., by fasteners, adhesives, welding, heat staking, etc.) or the like).

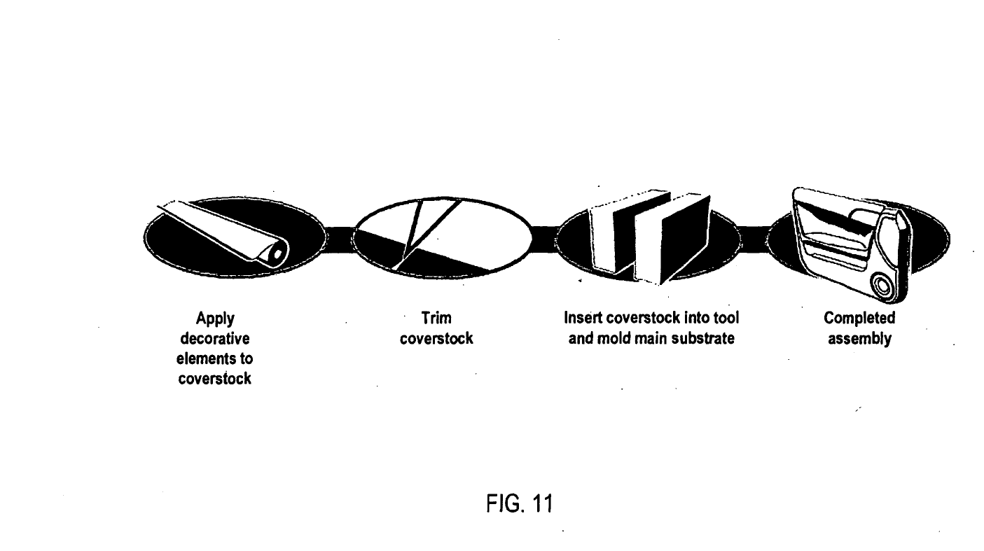

FIG. 11 is a flow diagram of a process of making a vehicle door panel with a coverstock with two or more printed decorative characteristics or elements according to an exemplary embodiment. The process includes printing the fabric so that it presents two or more decorative characteristics or elements. These characteristics may be provided, for example, by one decorative characteristic that is a printed indicia and another decorative characteristic that is another (e.g., different) printed indicia, the base appearance of the fabric (itself, a texture, or the like. The preformed sheet may then be trimmed to a desired shape or configuration. The trimmed fabric is then inserted into the mold tool and the substrate is molded by injection of plastic resin.

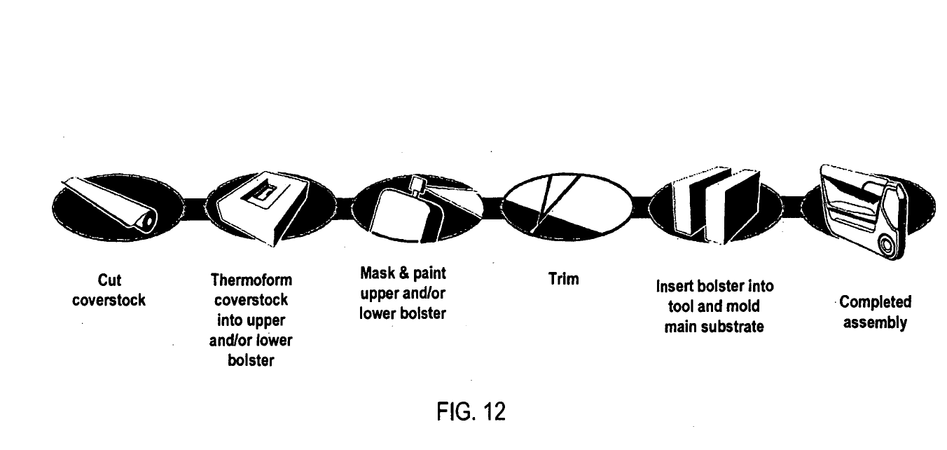

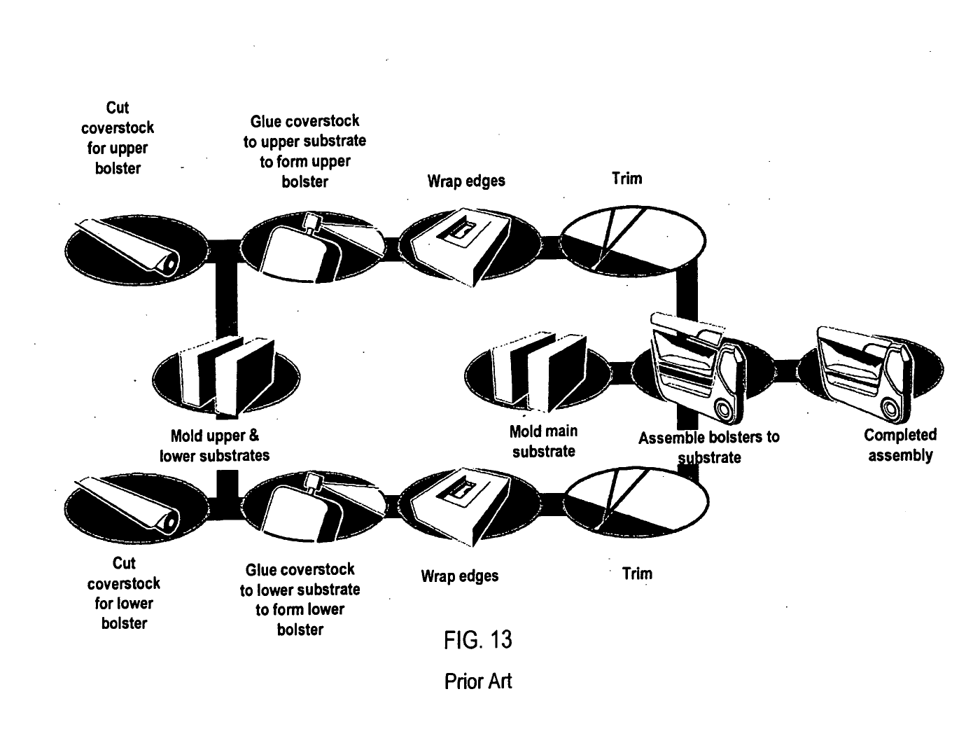

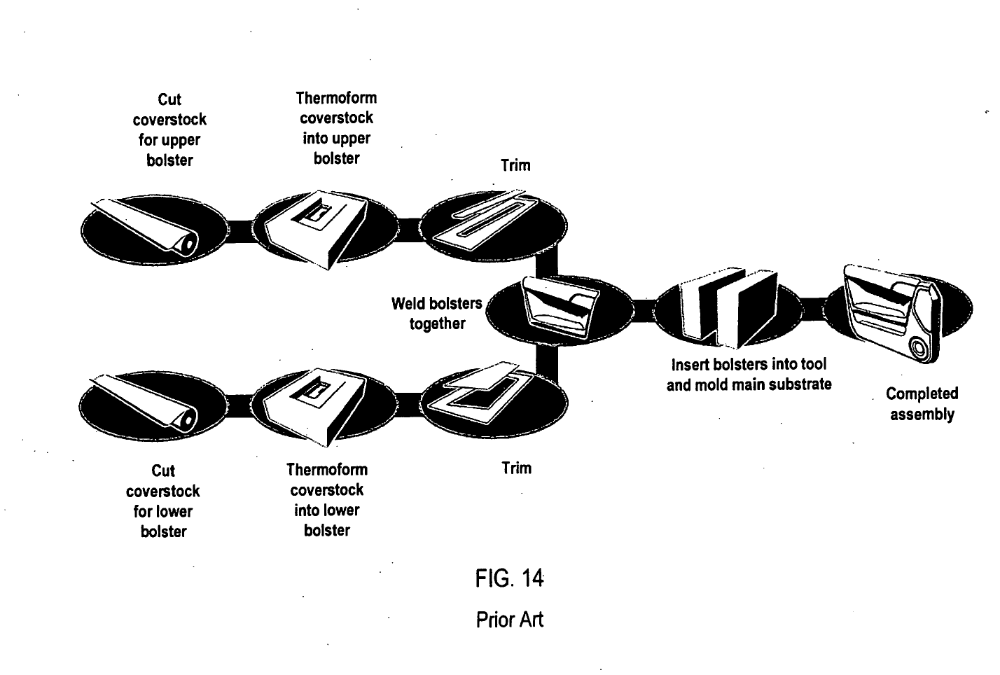

FIG. 12 is a flow diagram of a process of making a vehicle door panel with a coverstock with two or more painted decorative characteristics or elements according to an exemplary embodiment. The process includes cutting a sheet that forms the coverstock and then preformed to a desired shape (e.g., by vacuum forming or the like). According to a preferred embodiment, the sheet comprises three layer laminate (i.e., a “tri-laminate”) of a vinyl topcoat layer, a foam layer, and a polypropylene backing layer. The laminate is heated and then vacuum formed to a desired shape with the division line (i.e., border) between the two decorative characteristics or elements residing in a formed recess or ditch. The formed coverstock is trimmed and then placed in a fixture. A paint mask is placed over the portion of the coverstock that is not to be painted (e.g., an upper or lower bolster) and the part is then painted. The painted preformed coverstock is then placed in an injection molding tool and plastic resin in injected to the mold to form the substrate. A portion of the substrate forms structural support for the coverstock and a portion of the substrate may also form a visible portion of the trim panel (e.g., part of the “A-surface”). The division or line between painted portions or between portions painted and not painted is located in the a recess or ditch formed in the substrate at the recess formed in the coverstock preform.

It is also important to note that the construction and arrangement of the elements of the vehicle trim panel as shown in the preferred and other exemplary embodiments is illustrative only. The method may be used for manufacture of any of a variety of trim panels having multiple decorative elements, which may be provided as any of a variety of shapes or configurations on the trim panel. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces (e.g. clamps, etc.) may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). It should be noted that the elements and/or assemblies of the system may be constructed from any of a wide variety of materials that provide sufficient strength or durability, in any of a wide variety of colors, textures and combinations. It should also be noted that the display system may be used in association with a rotating display, or alternatively other, fixed and non-movable displays or any of a wide variety of other surfaces in any of a wide variety of other applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

1. A panel for use in a vehicle interior, the panel comprising:
a coverstock having a first portion with a first ornamental appearance, a second portion with a second ornamental appearance different than the first ornamental appearance, and a border between the first portion and the second portion;
a substrate at least partially molded behind the coverstock;
wherein the border between the first portion and the second portion is located in a recess formed in the substrate.

2. The panel of claim 1 wherein the coverstock is a unitary one-piece integral member.

3. The panel of claim 2 wherein the first ornamental appearance comprises at least one of an indicia, pattern, texture, material deposit, color, or combination thereof.

4. The panel of claim 3 wherein the second ornamental appearance comprises at least one of an indicia, pattern, texture, material deposit, color, or combination thereof.

5. The panel of claim 3 wherein the second ornamental appearance comprises an unaltered appearance of the coverstock.

6. The panel of claim 1 wherein the coverstock is a sheet of material selected from the group of textile, fabric, natural, polymer, or combinations thereof.

7. The panel of claim 1 wherein the coverstock is thermoformed to a desired shape before the substrate is molded.

8. The panel of claim 1 wherein the coverstock comprises a first layer and a second layer coupled to the first layer.

9. The panel of claim 8 wherein the first layer bonds to the substrate and the second layer provides a portion of an A-surface of the panel.

10. The panel of claim 1 wherein the substrate is molded behind a portion of the coverstock.

11. The panel of claim 1 wherein the substrate is molded behind the entire coverstock.

12. The panel of claim 1 wherein the panel is for use in a vehicle interior door trim panel.

13. A method of forming a panel comprising:
providing a coverstock between a first mold section and a second mold section, the coverstock having a border separating a first portion with a first ornamental appearance and a second portion with a second ornamental appearance, one of the first mold section and second mold section having a recess and the other of the first mold section and second mold section having a projection aligned with the recess;
moving the first mold section toward the second mold section so that the projection pushes a portion of the coverstock at least partially into the recess; and
injecting a polymer resin between the coverstock and the first mold section to form a substrate so that the border is located in a recess formed in the substrate.

14. The method of claim 13 wherein the coverstock comprises a unitary one-piece material.

15. The method of claim 13 further comprising locating the border on the coverstock so that it is located within the recess of the substrate.

16. The method of claim 13, wherein the step of providing the coverstock comprises applying at least one of an indicia, texture, color, or combinations thereof to the coverstock for the first ornamental appearance.

17. The method of claim 16 wherein the step of applying comprises at least one of printing, painting, embossing, depositing material, or combinations thereof.
